(19) United States
(12) Patent Application Publication
(10) Pub. No.: US 2021/0131541 A1
(43) Pub. Date: May 6, 2021

(54) HYBRID DRIVE MODULE FOR A MOTOR VEHICLE

(71) Applicant: ZF FRIEDRICHSHAFEN AG, Friedrichshafen (DE)

(72) Inventors: Monika RÖßNER, Donnersdorf (DE); Gerald VIERNEKES, Hassfurt (DE); Wolfgang KUNDERMANN, Dornburg-Dorndorf (DE); Wolfgang GROßPIETSCH, Schweinfurt (DE); Martin BREHMER, Tettnang (DE); Thomas RIEDISSER, Sigmarszell (DE); Thilo SCHMIDT, Meckenbeuren (DE)

(21) Appl. No.: 17/046,553

(22) PCT Filed: Mar. 12, 2019
(86) PCT No.: PCT/EP2019/056098

§ 371 Date: Oct. 9, 2020

(30) Foreign Application Priority Data
Apr. 11, 2018 (DE) 10 2018 205 463.0

(51) Int. Cl. F16H 45/02; F16D 25/0638; H02K 7/00; H02K 7/10

(52) U.S. Cl. CPC F16H 45/02; F16D 25/0638; B60K 6/387; H02K 7/10; F16H 2045/0284; H02K 7/006

(57) ABSTRACT

A hybrid drive module for a motor vehicle having an input shaft, an electric machine with a stator fixed with respect to relative rotation and a rotatable rotor, a disconnect clutch in the power flow between the input shaft and the rotor, and a torque converter with a lockup clutch, the housing of the torque converter being connected to the rotor so as to be fixed with respect to rotation relative to it. The disconnect clutch is actuatable in closing direction by pressurization of a first pressure space. The lockup clutch is actuatable in closing direction through pressurization of a second pressure space. The two pressure spaces are defined at least partially by the housing of the torque converter. The housing of the torque converter separates the first pressure space directly from the second pressure space.

The invention is directed to a hybrid drive module for a motor vehicle. The hybrid drive module can be an integral component part of a motor vehicle transmission or can be formed as an independent unit with at least one interface to a motor vehicle transmission. The invention is further directed to a powertrain for a motor vehicle with a hybrid drive module of this kind.

Patent Application DE 10 2009 020 672 A1 describes a combined power transmission and drive unit for use in a hybrid system having an electric machine, a clutch device for interrupting a power flow between a work machine and the rotor of the electric machine, a torque converter connected to the rotor, and a device for at least partially bypassing the hydrodynamic power split of the torque converter. Various configurations of the torque converter and actuation of the bypass device are described, particularly a two-channel arrangement and a three-channel arrangement. In contrast to a three-channel arrangement, there is no separate pressure space in a two-channel arrangement for the actuation of the bypass device. However, a specific constructional design of the power transmission and drive unit with three-channel arrangement of the torque converter is not disclosed.

German Patent Application DE 10 2011 109 702 A1 describes a torque converter with a housing element which is formed in one piece and which forms a plate carrier of a converter lockup clutch and the plate carrier of a disconnect clutch. Further, the housing element together with an actuation piston forms a pressure chamber for actuating the converter lockup clutch and the disconnect clutch. Both the converter lockup clutch and the disconnect clutch are enclosed by the one-piece housing element. The disclosure is limited to line drawings, and a specific constructional design is not described.

It is the object of the invention to further develop the constructions known from the prior art in order to provide a hybrid drive module that is constructed as inexpensively and compactly as possible.

This object is met through the features of patent claim 1. Advantageous embodiments will be apparent from the subclaims, the description and the drawings.

A hybrid drive module for a motor vehicle is proposed which has an input shaft, an electric machine with a stator which is fixed with respect to relative rotation and a rotatable rotor, a disconnect clutch in the power flow between the input shaft and the rotor, and a torque converter, the housing of the torque converter being connected to the rotor so as to be fixed with respect to rotation relative to it. The torque converter has a lockup clutch which is arranged inside of the torque converter housing and which is adapted to bridge the hydrodynamic path of the torque converter, that is, to mechanically connect the impeller wheel and turbine wheel of the torque converter.

The disconnect clutch is actuated in closing direction by pressurization of a first pressure space via a first piston. In contrast to the arrangement according to DE 10 2011 109 702 A1, the first pressure space is located outside of the torque converter housing. The lockup clutch is actuated in closing direction through pressurization of a second pressure space via a second piston. The second pressure space is provided exclusively for actuation of the lockup clutch and is arranged inside of the torque converter housing. In other words, a torque converter with at least three connection lines is used in the hybrid drive module according to the present invention. The at least three connection lines are made up of the following: an oil inlet duct for the toroidal space of the torque converter, an oil outlet duct for the toroidal space of the torque converter, and an oil duct for the pressure supply of the second pressure space. A fourth connection line can optionally be provided for the supply of an independent pressure compensation space for the lockup clutch.

According to the invention, it is provided that both the first pressure space and the second pressure space are defined at least partially by the housing of the torque converter. While this is undoubtedly the case for the first pressure space in the solution according to DE 10 2009 020 672 A1, it is not immediately or clearly apparent from FIG. 5 of the above-cited publication that the second pressure space has an arrangement of this kind. The torque converter housing separates the first pressure space directly from the second pressure space. In other words, a portion of the torque converter housing forms a boundary of the first pressure space and also a boundary of the second pressure space. Such an arrangement of the two pressure spaces utilizes existing component parts which are provided in any case, so that the number of parts in the hybrid drive module according to the invention can be minimized.

A first piston for actuation of the disconnect clutch is associated with the first pressure space. In identical fashion, a piston for the actuation of the lockup clutch is associated with the second pressure space. According to a preferred arrangement, the effective surface of the first piston is smaller than the effective surface of the second piston. This is advantageous particularly when a torque converter with a three-channel arrangement is used, since the second pressure space acts against the pressure present in the toroidal space of the torque converter. The first pressure space usually acts against a comparatively lower lubricating pressure.

The first pressure space and the second pressure space are preferably at least partially arranged radially one above the other. In other words, the two pressure spaces are arranged to be radially nested. The geometry of the torque converter housing required for this purpose is stiffer than a straight-line housing wall so that the actuation pressure for the disconnect clutch and for the lockup clutch leads to a lesser extent to a deformation of the torque converter housing. The second piston preferably at least partially surrounds the first pressure space. In other words, portions of the second piston are arranged radially outwardly of and also radially inwardly of the first pressure space.

According to a preferred embodiment, the torque converter housing has an undercut, i.e., an area with axially reduced dimensions in relation to the overall length of the torque converter housing. This undercut is adapted to guide the first piston. The undercut alone need not guide the first piston; rather, other surfaces can also be provided for guiding the first piston. An arrangement of this kind utilizes an existing component part that is provided in any case to guide the first piston so that the number of parts for the hybrid drive module according to the invention can be minimized.

The housing of the torque converter is preferably connected to a hub so as to be fixed with respect to rotation relative to it. The hub preferably serves to rotatably support the torque converter and is constructed, for example, as a rotating part, while the torque converter housing usually forms a sheet metal construction. The hub preferably has at least one fluid channel for the fluid supply of the first pressure space. The fluid channel may be formed as a bore hole, for example. The hub preferably has, in addition, a second fluid channel for the fluid supply of the second pressure space or defines a fluid channel of this kind at least partially. Therefore, the hub participates in forming the fluid supply of at least one of the pressure spaces. Channels of this kind are particularly easy to produce in a rotational part by means of bore holes, for example. Therefore, the hub is especially suited to this purpose.

According to a preferred embodiment, both the disconnect clutch and the lockup clutch are formed as wet multiple plate clutches. An outer plate carrier of the disconnect clutch is connected to the torque converter housing so as to be fixed with respect to rotation relative to it. This allows for a particularly compact construction of the hybrid drive module. The outer plate carrier is preferably riveted to the torque converter housing. The rivet connection can be arranged inside of the first pressure space. The rivet connection can be arranged in a region of the torque converter housing which defines the second pressure space.

The hybrid drive module is preferably an integral component part of a motor vehicle transmission. The one-part or multiple-part housing of the hybrid drive module accommodates planetary gear sets and shifting elements, for example, by means of which a plurality of gears are shiftable between an input shaft and an output shaft of the transmission. Instead of planetary gear sets and shifting elements, the transmission may also comprise a friction drive with displaceable wheels by means of which the transmission ratio between the input shaft and output shaft is continuously variable. The transmission can also be constructed as a single-clutch or dual-clutch transmission which utilizes switchable pairs of spur gears for shifting.

Alternatively, the hybrid drive module may be formed as an independent unit with an interface to a motor vehicle transmission. The hybrid drive module is separable from the transmission in this case.

The hybrid drive module can be a component part of a powertrain of a motor vehicle. The electric machine of the hybrid drive module can be provided for driving the motor vehicle and/or for starting an internal combustion engine of the powertrain.

Embodiment examples of the invention are described in detail in the following referring to the accompanying drawings. The drawings show:

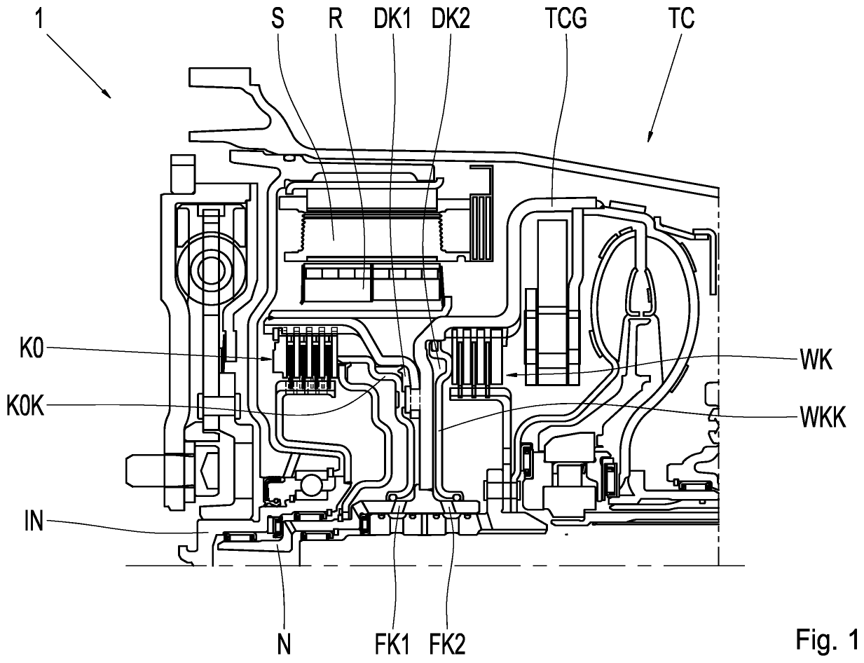

FIG. 1 to FIG. 3 sectional views of different embodiment examples of a hybrid drive module according to the invention; and

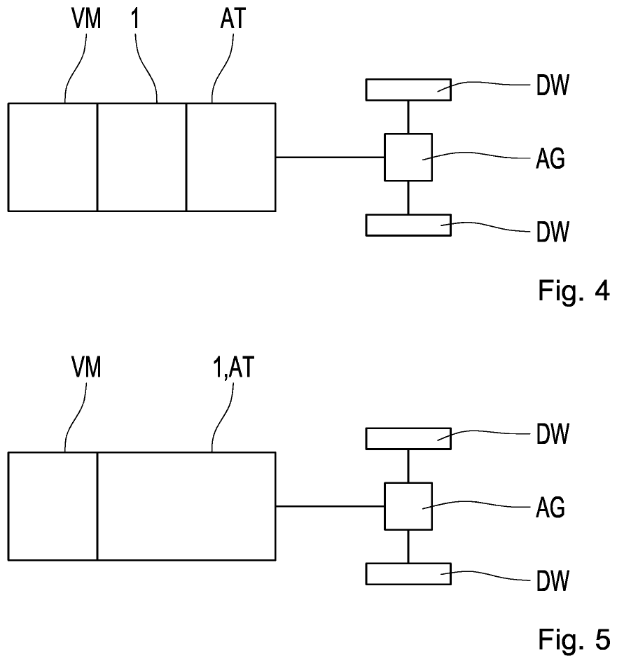

FIG. 4 and FIG. 5 a powertrain for a motor vehicle.

FIG. 1 shows a sectional view of a hybrid drive module 1 according to a first embodiment example. The hybrid drive module 1 has an input shaft IN, an electric machine with a stator S which is fixed with respect to relative rotation and a rotatable rotor R, a disconnect clutch K0 in the form of a multiple plate clutch, and a torque converter TC. By closing the disconnect clutch K0, the input shaft IN is connectable to the rotor R which is connected to a housing TCG of the torque converter TC. To this end, the input shaft IN is connected to an inner plate carrier of the disconnect clutch K0, while the rotor R is connected to an outer plate carrier of the disconnect clutch K0. The torque converter TC has a lockup clutch WK which is arranged inside the housing TCG and which is configured to connect the impeller wheel and turbine wheel of the torque converter TC to one another and accordingly to short-circuit the hydrodynamic path of the torque converter TC by mechanical means. The lockup clutch WK is formed as a multiple plate clutch.

Both the disconnect clutch K0 and the lockup clutch WK can be hydraulically actuated. A first pressure space DK1 which is arranged outside of the housing TCG is provided for actuating the disconnect clutch K0. When the pressure in the first pressure space DK1 is increased, a first piston K0K is displaced in direction of a lamination stack of the disconnect clutch K0 against the force of a return spring, not shown in FIG. 1. The disconnect clutch K0 is accordingly actuatable in closing direction through pressurization of the first pressure space DK1. A pressure compensation space which is limited in axial direction by an orifice plate is provided on the front side of the first piston K0K remote of the first pressure space DK1.

A second pressure space DK2 which is arranged inside of the housing TCG is provided for actuation of the lockup clutch WK. When the pressure in the second pressure space DK2 increases, a second piston WKK is displaced in direction of a lamination stack of the lockup clutch WK against the force of a further return spring, not shown in FIG. 1. Accordingly, the lockup clutch WK can be actuated in closing direction through the pressurization of the second pressure space DK2. There is no independent pressure compensation space provided on the front side of the second piston WKK remote of the second pressure space DK2. Instead, the pressure in the second pressure space DK2 acts against the pressure present in the toroidal space of the torque converter TC. The effective surface of the second piston WKK is larger than the effective surface of the first piston K0K. By “effective surface” is meant the cross-sectional area of the pistons K0K, WKK acted upon by the pressure in the respective pressure space DK1, DK2.

The first pressure space DK1 and the second pressure space DK2 are limited at least partially by the housing TCG. In other words, the pressure in the pressure spaces DK1, DK2 is directly supported at the housing TCG. The housing TCG directly separates the first pressure space DK1 from the second pressure space DK2.

The housing TCG is connected, for example, by means of a weld connection, to a hub N so as to be fixed with respect to rotation relative to it. The hub N can be produced, for example, by a cutting process, while the housing TCG is usually produced by forming. The hub N has a first fluid channel FK1 in the form of a bore hole which is provided for the fluid supply of the first pressure space DK1. The hub N further has a second fluid channel FK2 which is provided for the fluid supply of the second pressure space DK2.

The outer plate carrier of the disconnect clutch K0 is connected by means of a rivet connection to the housing TCG so as to be fixed with respect to rotation relative to it. The rivet connection or rivet head is located inside of the first pressure space DK1.

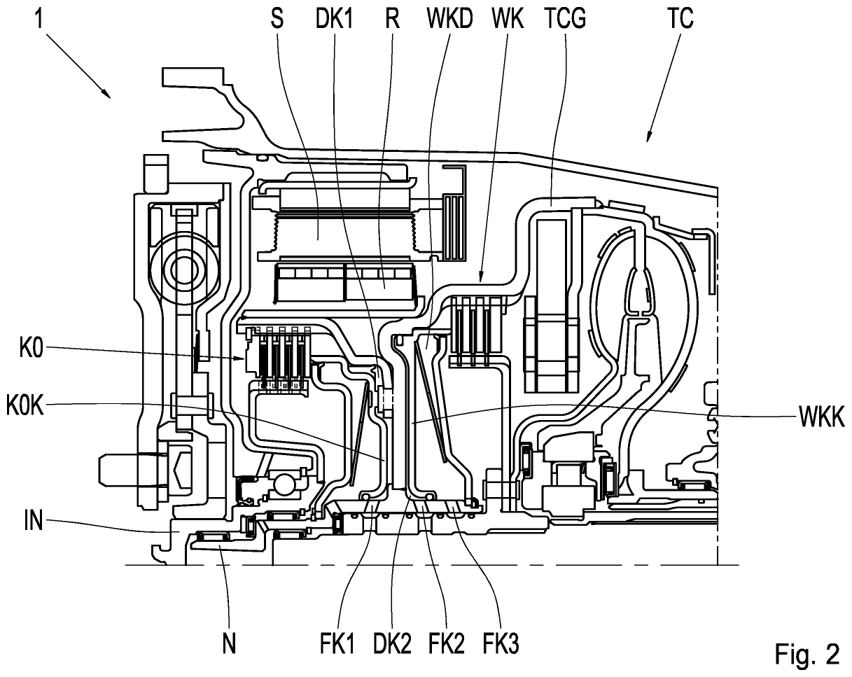

FIG. 2 shows a sectional view of a hybrid drive module 1 according to a second embodiment example which substantially corresponds to the first embodiment example shown in FIG. 1. The torque converter TC has four hydraulic connections so as to make possible a fluid supply of a pressure compensation space associated with the lockup clutch WK. A third fluid channel FK3 is provided in the hub N for supplying this pressure compensation space.

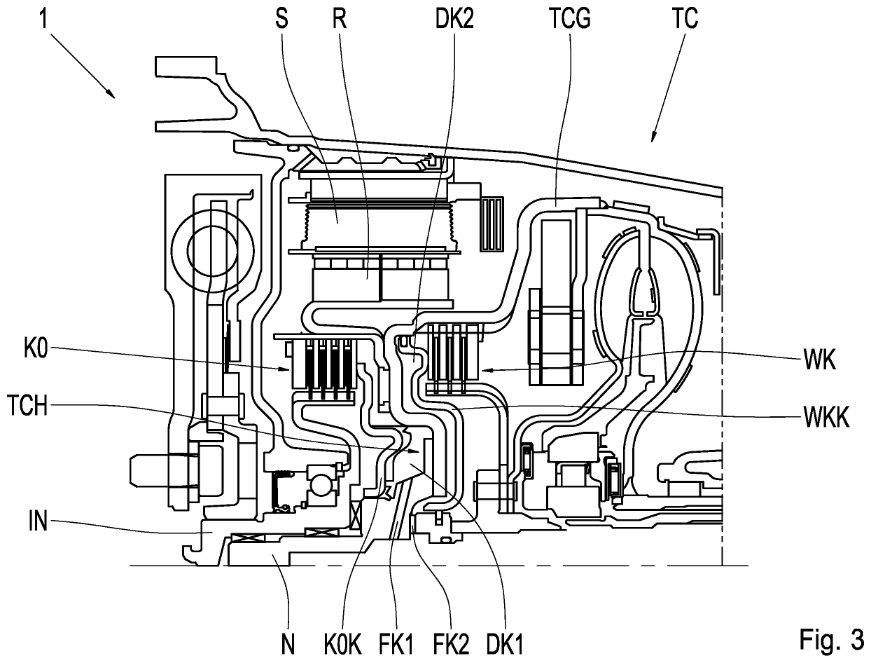

FIG. 3 shows a sectional view of a hybrid drive module 1 according to a third embodiment example. In contrast to the other embodiment examples, the housing TCG has an undercut TCH in the region of the hub N. The two pressure spaces DK1, DK2 are arranged partially radially one above the other. In other words, portions of the two pressure spaces DK1, DK2 are arranged in a common plane at right angles to the rotational axis of the assembly comprising rotor R and housing TCG. The second piston WKK surrounds the first pressure space DK1 in radial direction. The housing TCG and the two pistons K0K, WKK are stiffened by means of this arrangement so that a pressure in the pressure spaces DK1, DK2 leads to a lesser extent to a deformation of the housing TCG and pistons K0K, WKK.

The torque converter TC used in the third embodiment example of the hybrid drive module 1 has three hydraulic connections. Accordingly, the lockup clutch WK does not have its own pressure compensation space associated with it. Therefore, the pressure in the second pressure space DK2 acts against the pressure in the toroidal space of the torque converter TC. The fluid supply of the second pressure space DK2 is carried out via the second fluid channel FK2, portions of which are defined by the hub N.

FIG. 4 shows a powertrain of a motor vehicle. The powertrain has an internal combustion engine VM, the hybrid drive module 1 and a transmission AT. The hybrid drive module 1 and transmission AT are separate units with at least one interface via which the hybrid drive module 1 and the transmission AT are connectable to one another. A hydraulic supply of the hybrid drive module 1 is preferably carried out via hydraulics of the transmission AT. On the output side, the transmission AT is connected to a differential AG, for example, via a universal joint shaft. The power applied to an output shaft of the transmission AT is distributed to drive wheels DW of the motor vehicle by means of the differential AG.

FIG. 5 shows a powertrain of a motor vehicle which substantially corresponds to the powertrain shown in FIG. 4. The hybrid drive module 1 and the transmission AT now form a common constructional unit. In other words, the hybrid drive module 1 is an integral component part of the transmission AT.

The powertrains shown in FIG. 4 and FIG. 5 are considered merely exemplary. Instead of the depicted construction with powertrain oriented longitudinal to the driving direction of the motor vehicle, a use of the invention in a powertrain oriented transverse to the driving direction is also conceivable. The differential AG can be integrated in the transmission G. The powertrain with the hybrid drive module 1 is also suitable for an all-wheel drive application.

### REFERENCE CHARACTERS

1 hybrid drive module
IN input shaft
N hub
S stator
R rotor
K0 disconnect clutch
K0K first piston
DK1 first pressure space
FK1 first fluid channel
TC torque converter
TCG housing
TCH undercut
WK lockup clutch
WKK second piston
DK2 second pressure space
FK2 second fluid channel
FK3 third fluid channel
VM internal combustion engine
AT transmission
AG differential
DW drive wheel

1.-13. (canceled)

14. A hybrid drive module for a motor vehicle, wherein the hybrid drive module, comprising:
an input shaft;
an electric machine with a stator which is fixed with respect to relative rotation and a rotatable rotor;
a torque converter, comprising a housing that is connected to the rotor so as to be fixed with respect to rotation relative to the rotor;
a first pressure space defined at least partially by the housing of the torque converter and arranged outside of the housing of the torque converter;
a first piston;
a disconnect clutch in a power flow between the input shaft and the rotor, wherein the disconnect clutch is actuatable in a closing direction by pressurization of the first pressure space via the first piston;
a second pressure space defined at least partially by the housing of the torque converter and arranged inside of the housing of the torque converter;
a second piston; and
a lockup clutch of the torque converter arranged inside of the housing of the torque converter and which is adapted to bridge a hydrodynamic path of the torque converter, wherein the lockup clutch is actuatable in a closing direction through pressurization of the second pressure space via the second piston, wherein the second pressure space is provided exclusively for actuation of the lockup clutch,
wherein the housing of the torque converter separates the first pressure space directly from the second pressure space.

15. The hybrid drive module according to claim 14, wherein an effective surface of the first piston is smaller than an effective surface of the second piston.

16. The hybrid drive module according to claim 14, wherein the first pressure space and the second pressure space are arranged partially radially one above the other.

17. The hybrid drive module according to claim 16, wherein the second piston at least partially surrounds the first pressure space.

18. The hybrid drive module according to claim 14, wherein the housing of the torque converter has an undercut configured to guide the first piston.

19. The hybrid drive module according to claim 14,
wherein the housing of the torque converter is connected to a hub so as to be fixed with respect to rotation relative to the hub, and
wherein the hub has at least one fluid channel configured for fluid supply of the first pressure space.

20. The hybrid drive module according to claim 19, wherein the hub at least partially defines a second fluid channel for the fluid supply of the second pressure space.

21. The hybrid drive module according to claim 14, wherein the disconnect clutch and the lockup clutch are each formed as multiple plate clutches, wherein an outer plate carrier of the disconnect clutch is connected to the housing of the torque converter so as to be fixed with respect to rotation relative to the housing of the torque converter.

22. The hybrid drive module according to claim 21, wherein an outer plate carrier of the disconnect clutch is riveted to the housing of the torque converter.

23. The hybrid drive module according to claim 22, wherein the rivet connection is arranged between the outer plate carrier of the disconnect clutch and the housing of the torque converter inside the first pressure space.

24. The hybrid drive module according to claim 22, wherein the rivet connection is arranged between the outer plate carrier of the disconnect clutch and the housing of the torque converter in a portion of the housing that defines the second pressure space.

25. The hybrid drive module according to claim 14, wherein the hybrid drive module is either an integral component part of a motor vehicle transmission or is formed as an independent unit with at least one interface to the motor vehicle transmission.

26. A powertrain for a motor vehicle, comprising:
a hybrid drive module, comprising:
an input shaft;
an electric machine with a stator which is fixed with respect to relative rotation and a rotatable rotor;
a torque converter, comprising a housing that is connected to the rotor so as to be fixed with respect to rotation relative to the rotor;
a first pressure space defined at least partially by the housing of the torque converter and arranged outside of the housing of the torque converter;
a first piston;
a disconnect clutch in a power flow between the input shaft and the rotor, wherein the disconnect clutch is actuatable in a closing direction by pressurization of the first pressure space via the first piston;
a second pressure space defined at least partially by the housing of the torque converter and arranged inside of the housing of the torque converter;
a second piston; and
a lockup clutch of the torque converter arranged inside of the housing of the torque converter and which is adapted to bridge a hydrodynamic path of the torque converter, wherein the lockup clutch is actuatable in a closing direction through pressurization of the second pressure space via the second piston, wherein the second pressure space is provided exclusively for actuation of the lockup clutch,
wherein the housing of the torque converter separates the first pressure space directly from the second pressure space.
